(19) United States
(12) Patent Application Publication
(10) Pub. No.: US 2008/0143620 A1
(43) Pub. Date: Jun. 19, 2008

(54) Increasing the bandwidth of a RFID dipole tag

(75) Inventor: Mohamed Fayaz S. Khatri, Kettering, OH (US)

Correspondence Address: ULMER & BERNE LLP;ATTN: DIANE BELL, 600 VINE STREET, SUITE 2800, CINCINNATI, OH, 45202, US

(73) Assignee: NCR Corporation

(21) Appl. No.: 11/638,657

(22) Filed: Dec. 13, 2006

(51) Int. Cl. H01Q 21/00; H01Q 7/00; H01Q 9/16

(52) U.S. Cl. 343/726; 343/810; 343/742

(57) ABSTRACT

An antenna arrangement that includes two or more electrically coupled antenna elements is described. Each of the antenna elements has different operational characteristics than the other antenna elements. The antenna elements are arranged to resonate generally about a first operational frequency to widen the operational bandwidth of the antenna arrangement.

### FIELD OF THE INVENTION

The present invention relates generally to antenna arrangements and more particularly, but by no means exclusively, to antenna arrangements for use in wireless devices such as Radio Frequency Identification Transponders (RFID).

### BACKGROUND OF THE INVENTION

In the field of wireless communications, the efficiency of a wireless circuit is largely governed by the performance of the antenna to which it is coupled. Antenna efficiency is dependent not only upon physical dimensions (ie size, shape and material composition) but also based on operational parameters. These may include input impedance, gain, directivity, radiation pattern and signal polarity.

In Radio Frequency Identification (RFID) transponder systems, the choice of antenna for an RFID tag is primarily limited by the small physical dimensions of the tag's substrate, the impedance of the integrated circuitry and the operational bandwidth. For an operable Ultra High Frequency (UHF) RFID tag antenna, the minimum physical dimension of the antenna is in the order of a quarter wavelength (or a multiple thereof) of the desired operating frequency and quarter-wavelength dipole antennas are commonly used.

Designated bands for RFID communication exist in most countries. Typically these bands will differ from country to country and as such, RFID tag antennas are designed to be operable in the frequency band corresponding to the country in which they are to be sold. For example, in the United States short range communication may be limited to a frequency band of between 902 to 928 MHz, while in Australia the specified operational band for short range communication may be 860 to 888 MHz. As a result, RFID tags which are designed to be operable in one country may not be operable in another country due to the different operational bands.

### SUMMARY OF THE INVENTION

An antenna arrangement is provided that includes two or more electrically coupled antenna elements having different operational characteristics. The two or more antenna elements are both arranged to resonate generally about a first operational frequency in order to widen the operational bandwidth of the antenna arrangement.

In general, in one aspect, two antenna elements having different operational characteristics may be combined such that their resonances overlap for widening the effective bandwidth. A wider bandwidth may allow the antenna to operate over a large range of signal frequencies, thereby making it suitable for use in different applications/systems operating in different frequency bands.

Implementations of the invention may include one or more of the following. The operational characteristics of the antenna elements may comprise an antenna gain, input impedance, effective length, input return loss, directivity, radiation pattern, quality factor and/or bandwidth. One of the antenna elements may be a loop antenna and another of the antenna elements may be a dipole antenna. The loop antenna may extend outwardly from the dipole antenna. The loop antenna may extend in the same plane as the dipole antenna and may be centred about the dipole antenna. The loop antenna may incorporate a side wall which runs parallel to the dipole antenna. In an alternative embodiment, both of the antenna elements are dipole antennas.

In general, in another aspect, the invention features a radio frequency communication device which comprises a processing unit and an antenna arrangement. The antenna arrangement includes two or more electrically coupled antenna elements having different operational characteristics and which are both arranged to resonate generally about a first operational frequency. In this manner, the antenna elements may effectively widen the operational bandwidth of the antenna arrangement.

In accordance with this aspect, the antenna elements may be arranged to receive/transmit signals over a widened band of frequencies making the radio frequency communication device suitable for use in different regions of the world that have different standards in frequencies. The radio frequency communication device may be a radio frequency identification transponder (RFID) tag. The processing unit may be responsive to radio frequency signals centred about the first operational frequency at the antenna.

In general, in another aspect, the invention provides a radio frequency communication system which comprises a radio frequency device including a processing unit and an antenna arrangement. The antenna arrangement includes two or more electrically coupled antenna elements having different operational characteristics and which are both arranged to resonate about a first operational frequency to widen the operational bandwidth of the antenna arrangement. The radio frequency communication system also includes a remotely positioned interrogator which is arranged to transmit a signal at the first operational frequency and the processing unit is responsive to the signal.

### BRIEF DESCRIPTION OF THE DRAWINGS

FIG. 1 is a schematic view of a typical RFID transceiver system;

FIG. 2 is an input return loss graph illustrating the operational bandwidth of the RFID transceiver tag depicted in the RFID transceiver system of FIG. 1;

FIG. 3 is a planar top view of an RFID transceiver tag incorporating an antenna arrangement in accordance with an embodiment of the present invention;

FIGS. 4 & 5 shows the converging of antenna element resonant frequencies as a result of manipulating their operational parameters to achieve a widened bandwidth about a desired operational frequency, in accordance with an embodiment of the present invention;

FIG. 6 is a perspective top view of an antenna arrangement (substrate not shown) in accordance with an alternate embodiment of the present invention; and

FIG. 7 is an input return loss graph for the antenna arrangement of FIG. 6, illustrating a widened operational bandwidth about a desired operational frequency.

### BRIEF DESCRIPTION OF THE DRAWINGS

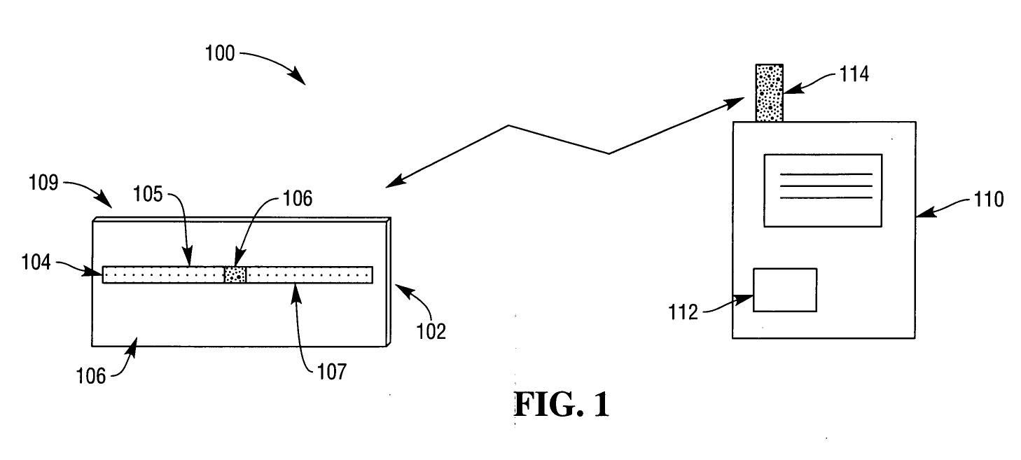

Operation of a typical prior art RFID system is described with reference to FIG. 1. The system 100 comprises an RFID tag 102 which includes a quarter-wavelength dipole antenna 104 mounted on a dielectric substrate 109. The dielectric substrate 109 is made from polyester sheet and has a dielectric constant of 3.4κ. The thickness of the substrate is approximately 4 millimetres. The RFID tag 102 also includes an integrated circuit 106 for performing processing operations and which is electrically coupled to both arms 105, 107 of the quarter-wave dipole antenna 104. An example of a suitable integrated circuit 106 is the “Gen 2 Monza Chip”, commercially available from Impinj Inc, United States. To minimise reflection of electromagnetic energy between the antenna 104 and the integrated circuit 106, and to thereby maximise the efficiency of the RFID tag 102, the real components of the antenna 104 and integrated circuit 106 input impedance are matched (either by design or by using a “matching circuit”). Further, to ensure optimum power transfer to the integrated circuit 106 (also referred to as the “power factor” of the antenna) for a specified operational frequency, the length and width of the two conductor arms 105, 107 are selected such that the complex impedance of the antenna 104 is a conjugate match to that of the integrated circuit. The “Gen 2 Monza Chip”, for example, has an impedance of 40−j95Ω. Thus, the antenna 104 is designed to have an impedance of 40+j95Ω. The physical dimensions of the conductor arms 105, 107 are approximately 9.4 centimetres by 0.8 centimetres.

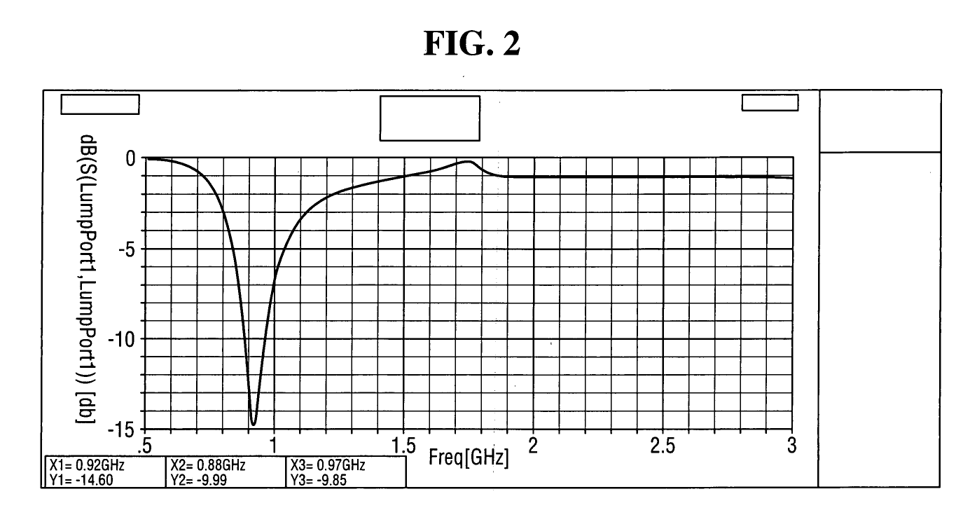

FIG. 2 is an input return loss graph illustrating the operational bandwidth of the antenna 104 of FIG. 1. From FIG. 2 it can be seen that the RFID tag 102 has an operational bandwidth of about 100 MHz centred about a resonant frequency of 920 MHz. The theory behind matching impedance values for achieving maximum antenna efficiency and power transfer is disclosed in RF Circuit Design-Theory and Applications, Ludwig and Bretchko, Prentice-Hall Inc, 2000, pp 406-444 and The Art of Electronics, Horowitz and Hill, Cambridge University Press, 1980, pp 656 to 569, which are both incorporated herein by reference.

An interrogation device 110 is provided for interrogating the RFID tag 102. The interrogation device includes communication electronics (not shown), memory 112 and an interrogation antenna 114. As used herein, the term “interrogation device” may comprise any device which is capable of wirelessly communicating with the RFID tag 102. Further, the signal used to communicate with the RFID tag 102 may be any one of a variety of different types of signal fields including electric, magnetic, or electro-magnetic. In the depicted embodiment, the interrogation device 110 communicates with the RFID tag 102 by emitting a modulated radio frequency signal through the interrogation antenna 114 using a carrier frequency corresponding to the resonant frequency of the RFID tag antenna 104, specified above.

When the RFID tag 102 is positioned in the presence of the radio frequency signal field emitted from the interrogation device 110, the antenna 104 resonates and a portion of the received energy is absorbed and subsequently transferred to the integrated circuit 106, where it is converted into electrical potential energy and stored. The electrical potential energy appears as a voltage at the internal power supply connections (not shown) of the integrated circuit 106. If the signal strength is above a predetermined threshold, the RFID tag 102 will respond to the reception of the signal by modulating the signal to impart information about the RFID tag 102 (which may be pre-programmed into the integrated chip 106) onto a back-scattered signal field which propagates back to the interrogation device 110. In embodiments where the RFID tag 102 is a passive tag, the signal strength must be sufficient for the integrated circuit 106 to rectify the signal and use the signals energy for the tag's power source.

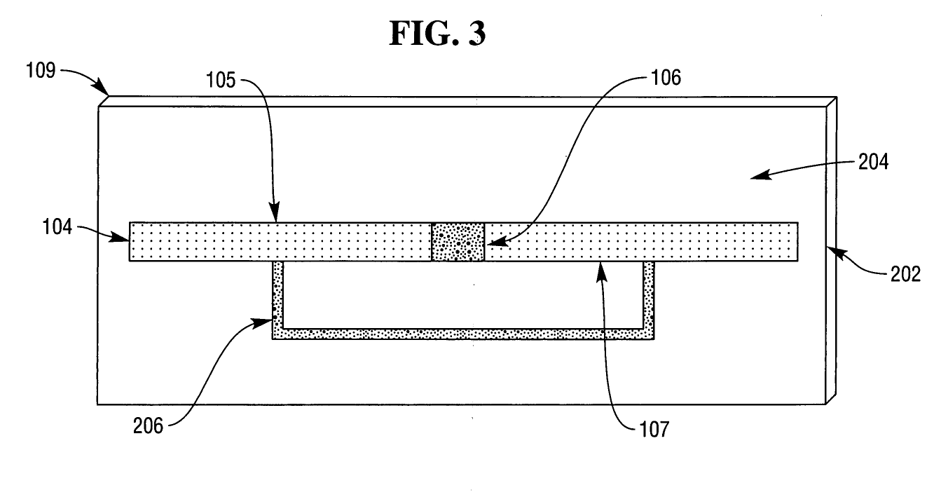

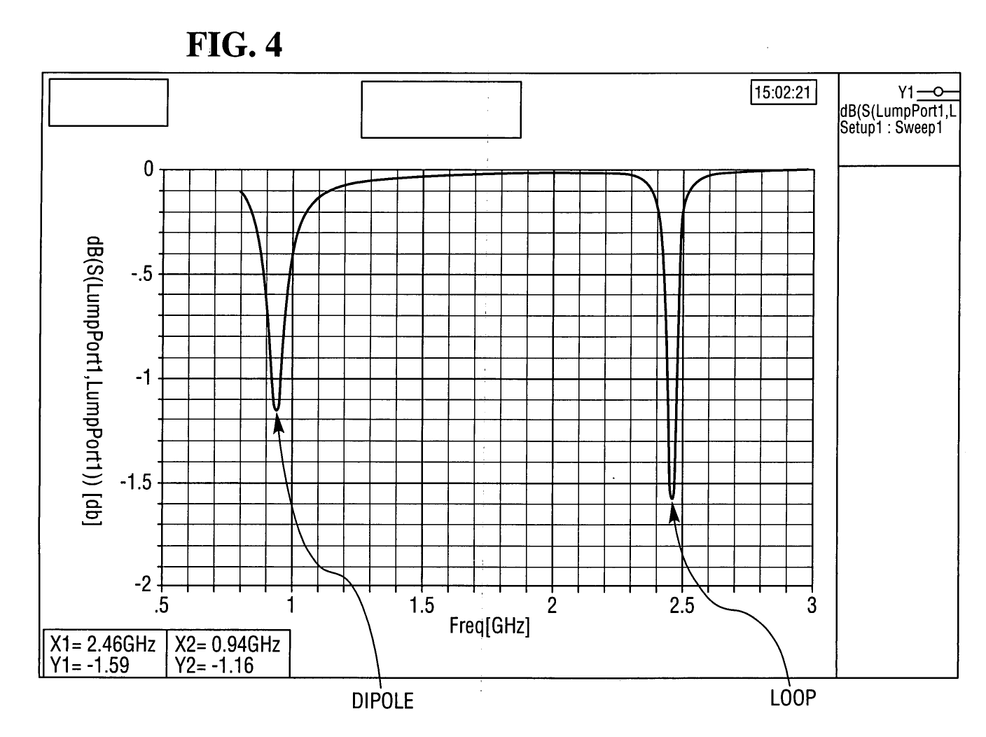

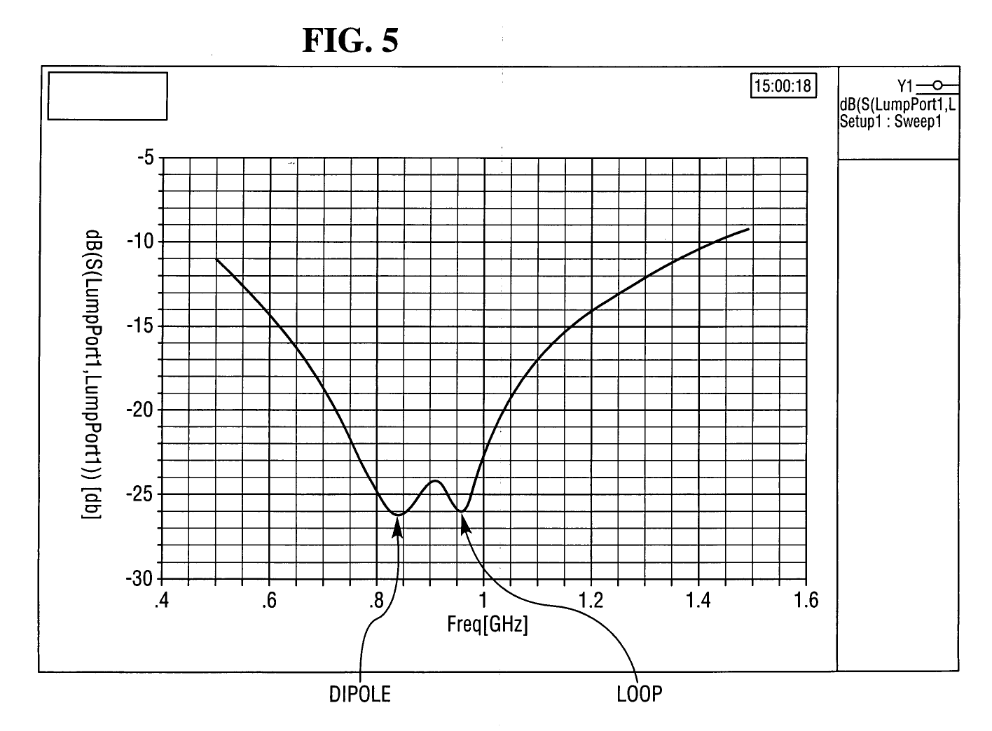

With reference to FIG. 3, there is shown an antenna arrangement 204 for an RFID tag in accordance with an embodiment of the present invention. The antenna arrangement 204 includes two or more electrically coupled antenna elements 104, 206 having different operational characteristics. The antenna element 104 is a quarter-wavelength dipole antenna having the same operational and physical characteristics as the dipole antenna of FIG. 1. The quarter-wavelength dipole antenna 104 is electrically coupled to the integrated chip 106. A second antenna element 206 is also provided on the dielectric substrate 109, such that when coupled to both arms 105, 107 of the dipole antenna 104, the second antenna element 206 effectively forms a square loop antenna 206. The physical length of the square loop antenna 206 is adjusted until the resonances of both antenna elements 104, 206 slightly overlap, thereby widening the effective bandwidth of the RFID tag 202. This is best shown with reference to the input return loss graphs of FIGS. 4 & 5.

FIG. 4 depicts an input return loss graph prior to the loop dimensions of the square loop antenna 206 being adjusted for overlapping resonance. Return loss is a function of frequency and is used here to show the ratio between the energy supplied to the antenna and the energy returning from the antenna back to the signal source, i.e. the efficiency of the antenna over a selected frequency range. From FIG. 4, it can be seen that the antenna elements 104, 206 are resonating at two distinctly different frequencies: the dipole antenna 104 (shown at the left of screen) resonates about a centre frequency of 0.94 MHz and has an associated bandwidth of around 90 MHz; while the square loop antenna 206 has a much higher resonant frequency of 2.46 GHz and slightly narrower bandwidth of about 60 MHz. In FIG. 5, the physical length of the square loop antenna 206 is adjusted causing the resonant frequency of the square loop antenna 206 to decrease such that it slightly overlaps with that of the dipole antenna 104. As a result, the operational bandwidth of the RFID tag antenna 202 is widened, thereby allowing a larger range of signal frequencies (between about 75 to 105 GHz at −20 db) to be received and/or transmitted by the RFID antenna arrangement 204 without overly compromising the gain of the antenna.

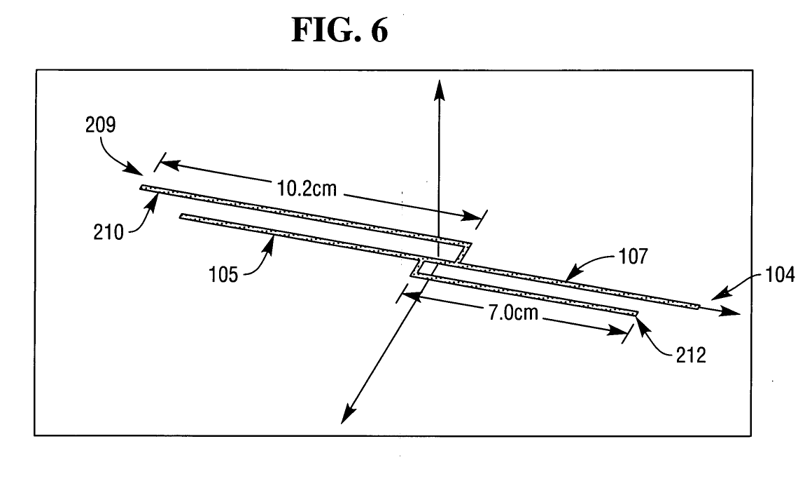

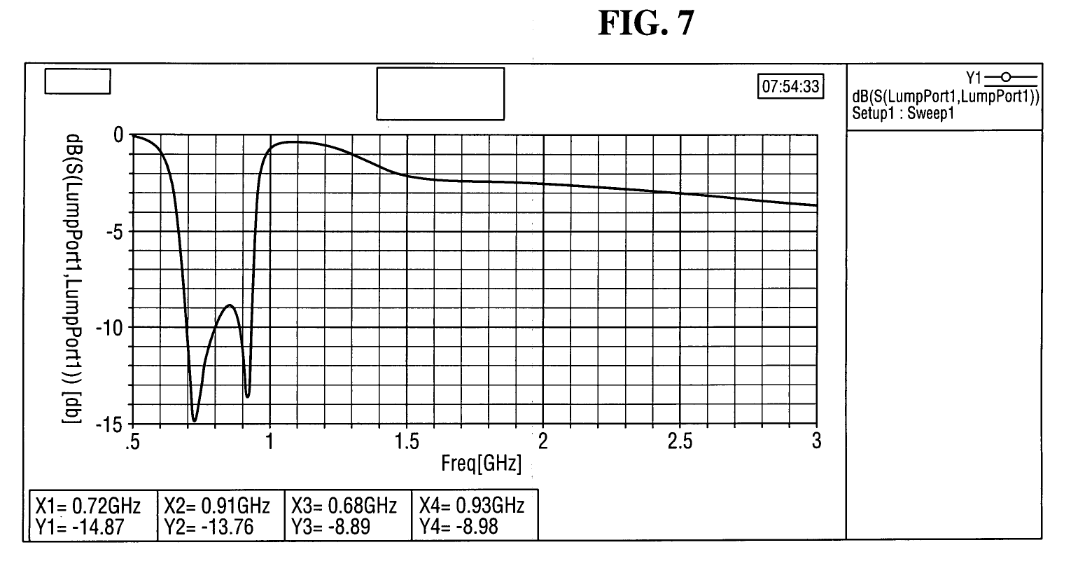

With reference to FIG. 6, there is shown an antenna arrangement 208 in accordance with an alternative embodiment of the present invention. According to this embodiment, the second antenna element 209 is in the form of a quarter-wave dipole antenna having first and second conductor arms 210, 212 which step outwardly from, and which extend in a direction parallel to, either conductor arm 105, 107 of the first antenna element 104. The length of the first and second antenna arms 210, 212 of the second antenna element 209 are set at 10.2 centimetres and 7.0 centimetres, respectively. The resulting return loss graph for the antenna configuration is shown in FIG. 7. It can be seen from FIG. 7 that the resonant frequencies for each of the antenna elements 104, 209 are slightly overlapping and result in an operational bandwidth of approximately 200 MHz; more than double the bandwidth of the prior art RFID tag of FIG. 1 which employs a single quarter-wave dipole antenna. The antenna arrangement 208 of FIG. 6 would be particularly suited for operation, for example, in any region where the RFID operable band falls between 0.72 GHz to 0.92 GHz.

According to the embodiments described above, it can be seen that antenna arrangements in accordance with the present invention exhibit a greatly widened operational bandwidth over typical RFID tag antennas, due to the two antenna elements having different operational characteristics resonating close together where maximum transfer of energy is occurring over a widened range of frequencies. This is particularly advantageous where communication over a widened range of frequencies is desirable. For example, the antenna arrangements according to embodiments of the present invention are suitable for use in devices which are sold in different geographical regions employing different operational spectrums.

It will be understood to those skilled in the art that the antenna elements may be made of any type of suitable conductive material, such as metal foils, etched aluminium, plated copper printed conductive patterns made from conductive inks, or any other conductive materials known in the art.

Furthermore, it is envisaged that other types of antenna which are well-known in the art may be used in combination to achieve widened bandwidth operation. For example the antenna elements may comprise of any one or more of folded dipole antennas, slot antennas, circular loop antennas etc; being limited only by the desired use and properties of the devices to which they are coupled.

It should also be understood to those skilled in the art that stubs may be added to physically alter the effective length (ie operational characteristic) of the antenna elements, rather than by altering their physical length as described in preceding paragraphs.

In the preceding description, an embodiment of the present invention was described in the context of an antenna arrangement for a passive RFID transponder tag operable in the UHF band and ranging generally between 850 MHz to 960 MHz. However, it should be understood that the present invention is not limited to the embodiment described herein and is equally applicable to other forms of wireless communication devices operable over different frequency bands.

1. A radio frequency communication device comprising:
a processing unit; and
an antenna arrangement electronically coupled to the processing unit, the antenna arrangement including two or more electrically coupled antenna elements having different operational characteristics, the two or more antenna elements are arranged to resonate generally about a first operational frequency to widen the operational bandwidth of the antenna arrangement.

2. A radio frequency communication device in accordance with claim 1, wherein the antenna elements are dipole antennas.

3. A radio frequency communication device in accordance with claim 1, wherein the operational characteristics of the antenna elements comprise at least one of an antenna gain, input impedance, effective length, input return loss, directivity, radiation pattern, quality factor and bandwidth.

4. A radio frequency communication device in accordance with claim 3, wherein the antenna elements are dipole antennas.

5. A radio frequency communication device in accordance with claim 3, wherein one of the two antenna elements is a loop antenna.

6. A radio frequency communication device in accordance with claim 5, wherein another of the antenna elements is a dipole antenna.

7. A radio frequency communication device in accordance with claim 6, wherein the loop antenna extends outwardly from the dipole antenna.

8. A radio frequency communication device in accordance with claim 6, wherein the loop antenna extends in the same plane as the dipole antenna.

9. A radio frequency communication device in accordance with claim 6, wherein the loop antenna is centred about the dipole antenna.

10. A radio frequency communication device in accordance with claim 9, wherein the loop antenna has a side wall running parallel to the dipole antenna.

11. A radio frequency communication device in accordance with claim 1, wherein the processing unit and antenna comprises a radio frequency identification transponder (RFID) tag.

12. A radio frequency communication device in accordance with claim 1, wherein the processing unit is responsive to radio frequency signals falling within the operational bandwidth.

13. A radio frequency communication system comprising:
a radio frequency device, which includes:
a processing unit; and
an antenna arrangement electronically coupled to the processing unit, wherein the antenna arrangement further includes two or more electrically coupled antenna elements having different operational characteristics, the two or more antenna elements are arranged to resonate generally about a first operational frequency to widen the operational bandwidth of the antenna arrangement; and
a remotely positioned interrogator arranged to transmit a signal within the operational bandwidth and wherein the processing unit is responsive to the signal.

14. A radio frequency communication system in accordance with claim 13, wherein the operational characteristics of the antenna elements comprise at least one of an antenna gain, input impedance, effective length, input return loss, directivity, radiation pattern, quality factor and bandwidth.

15. A radio frequency communication system in accordance with claim 13, wherein the processing unit and antenna comprises a radio frequency identification transponder (RFID) tag.

16. A radio frequency communication system in accordance with claim 13, wherein the processing unit is responsive to radio frequency signals falling within the operational bandwidth.
